(19) United States
(12) Patent Application Publication
(10) Pub. No.: US 2004/0085299 A1
(43) Pub. Date: May 6, 2004

(54) Combined touchscreen and membrane switch

(76) Inventors: Jianming Huang, Windhan, NH (US); Malcolm Howie, Foxborough, MA (US)

Correspondence Address: QUARLES & BRADY LLP, 411 E. WISCONSIN AVENUE, SUITE 2040, MILWAUKEE, WI, 53202-4497, US

(21) Appl. No.: 10/284,570

(22) Filed: Oct. 30, 2002

(51) Int. Cl. G09G 5/00

(52) U.S. Cl. 345/173

(57) ABSTRACT

A combined membrane switch and touchscreen employs a continuous front transparent sheet that directly supports a transparent electrode for the touchscreen and graphics for the membrane switch portion of the assembly. Improved transparency and reduced touch activation pressure is thereby obtained.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates to electrical membrane switches and, in particular, to a combination of one or more membrane switches and a touchscreen such as may fit over a graphic display terminal.

Membrane switches provide front and rear sheets held in separation by a spacer layer. In one common version, electrical contacts are printed with conductive inks on the opposed surfaces of the front and rear sheets. The conductive inks may for example be those including metallic silver inks applied by a printing process such as silk screening.

The front sheet of the membrane switch is flexible so that it may be deformed inward, by pressure of a fingertip or the like, to touch the rear sheet through apertures in the spacer layer. When the sheets touch, the electrical contacts on their surfaces allow the flow of electrical current. A desirable property of membrane switches is that they present a continuous front surface resistant to contamination from moisture and dirt.

In a well known variation on the above design, the conductor on the front sheet is replaced with “a snap dome” being conductive or having a conductor printed on its surface facing the rear sheet. Pressure on the front sheet may cause the snap dome to snap from its convex configuration with its rear surface removed from the rear sheet to a concave mode in which its rear surface and conductor shorts conductive fingers on the rear sheet, again allowing current flow.

A single front and rear sheet may provide for a number of separately actuable switches or button by printing separate conductors and forming multiple apertures in the spacer layer. Normally the front layer is printed with button symbols denoting the location of these switches and where pressure should be applied to activate each switch. The front layer is typically transparent with button symbols printed on the rear surface to protect them from abrasion.

In contrast to a membrane switch, a resistive touchscreen provides an indication of a touch point arbitrarily located on the face of a CRT or other electronic display screen. Like a membrane switch, a resistive touchscreen employs front and rear sheets with conductive coating material, but in a touchscreen the conductive coating must be a transparent material such as ITO (Indium Tin Oxide) to allow viewing of the terminal on which they are overlaid. In a resistive touchscreen (in contrast to a matrix touchscreen which works like a membrane switch), the conductive materials are laid continuously over the front and rear surface rather than in discrete locations. An ITO coating is relatively expensive and so the area of the touchscreen is ordinarily sized closely to the area of the display screen to minimize the amount of ITO required.

There are many kinds of resistive touchscreens (Three-wire, Four-wire, Five-wire, Six-wire, Seven-wire, and Eight-wire resistive touchscreens). All of these resistive touchscreens measure a voltage gradient produced as current flows through the transparent resistive coating. The Three-wire, Five-wire, Six-wire, and Seven-wire touchscreens utilize a slightly different detection algorithm than the Four-wire and Eight-wire touchscreens.

With Five-wire resistive touchscreen, a DC voltage, for example 5V, is first applied vertically to the rear sheet of uniform conductive material (first, second, third and fourth wires). This will create a voltage gradient from top to bottom. When the front sheet is touched, the conductive material of the front sheet, which connects to controller electronics (via the fifth wire), probes the voltage at the touch point of rear sheet. The percentage of probed voltage over 5V will be the percentage of the distance of the touch point over the height of the touchscreen. For example, if probed voltage is 2.5V, that means the middle of the height of the touch screen has been touched. Once the vertical location is determined, the DC 5V is switched to be applied horizontally to the conductive material of rear sheet (first, second, third and fourth wires). The probed voltage at touching point will then tell the horizontal location of the touch point.

For Four-wire resistive touchscreens, the vertical location is detected just like with the Five-wire touchscreen with the gradient applied via the first and second wires and using one or both of third and fourth wires on the front sheet to probe the voltage. However the horizontal location is detected by applying the dc voltage to the front sheet using the third and fourth wires and using the rear sheet conductive to probe the voltage via one or both of the first and second wires.

For the purpose of accurately locating the touch point, it is desirable that the conductive material on the touchscreen has a very uniform resistive distribution in front and rear sheets for Four-wire resistive touchscreen and very uniform resistive distribution in rear sheet for five-wire resistive touchscreen. In contrast, the conductors used in the membrane switch are desirably those having the lowest practical resistance only. In following disclosure, resistive touch referring to this invention includes all different types of resistive touchscreens as described above.

Membrane switches and a touchscreen may be used together, for example, on an input terminal where membrane switches flank the display screen. The membrane switches may provide fixed location functions and the touchscreen may provide functions based on the output of the display screen. One method of combining membrane switches and a touchscreen for applications like this is to cut a window in the center of a membrane switch panel through which the touchscreen is exposed. This approach creates sealing difficulties that may allow contaminates to enter through the cut out area and may therefore defeat one of the desirable properties of such switches. An alternative method of combining membrane switches and a touchscreen is to mount the touchscreen under the top layer of the membrane switch. This top layer which normally supports graphics for the membrane switch is left clear in the area of the touchscreen. Although this approach eliminates the problems with a seam, the graphics layer of the membrane switch over the touchscreen significantly increases the touch activation force for the touchscreen and reduces the optical transmission of light from the display screen.

Desirably a combined membrane switch and touchscreen could be produced without these drawbacks.

### BRIEF SUMMARY OF THE INVENTION

The present invention provides a combined touchscreen and membrane switch having a single continuous front layer that is shared by the membrane switch as its graphics layer and the touchscreen as supporting its conductive material. Use of a single layer for these two purposes improves optical transmission through the touchscreen and reduces the amount of force needed to activate the touchscreen.

The membrane switches may also use this top layer for support of their electrodes or may include a second electrode support layer. This latter option increases the force of activation slightly for the membrane switch, but this is acceptable for membrane switch operation. The rear transparent layer of the touchscreen may also be extended to provide a portion of the membrane switch circuitry.

Specifically then, the present invention provides a combined touchscreen and membrane switch sharing a front layer formed of a continuous flexible sheet with a transparent portion supporting a transparent conductor on a rear surface, and a graphic portion printed with button symbols. A spacer layer is positioned behind the front layer and has openings aligned with the transparent portion and at least one button symbol. A transparent rear layer is positioned behind the spacer layer to support a transparent conductor on a front surface opposed to the transparent portion of the front layer. Membrane switch circuitry is positioned behind the graphic portion of the front layer and aligned with the button symbols to be activated upon pressing of the button symbols.

It is one object of the invention to provide a combined touchscreen/membrane switch presenting a seamless front surface and touch activation force for the touchscreen comparable with stand alone touchscreens.

The graphic portion of the front layer may also support a conductor on its rear surface.

Thus, it is another object of the invention to use the front layer as an electrode support both for the membrane switch and touchscreen simplifying the design and further reducing the force required to activate the touchscreen.

The conductor on the rear surface of the graphic portion of the front layer may be of a material different from the conductor on the rear surface of the transparent portion of the front layer.

Thus, it is another object of the invention to optimize conductors for touchscreens and membrane switches on a single layer.

The conductor on the rear surface of the transparent portion of the front layer may be a conductive polymer.

Thus it is yet another object of the invention to provide a transparent conductor that may be patterned locally on a continuous front layer to significantly reduce the cost of using a single front layer for both a membrane switch and a touchscreen.

The transparent rear layer may extend behind both the transparent portion and the graphics portion of the front layer and the membrane switch circuitry may include a conductor supported on the front surface of the rear layer behind the graphic portion of the front layer.

Thus, it is another object of the invention to provide a simple design in which a single layer supports circuitry for both the membrane switches and the touchscreen.

Many of the objects and advantages described above apply to only some embodiments falling within the claims and thus do not define the scope of the invention.

### BRIEF DESCRIPTION OF THE DRAWINGS

FIG. 1 is an exploded perspective view of the touchscreen/membrane switch assembly of the present invention as positioned in front of a display screen showing transparent portions and graphic portions of the assembly;

FIG. 2 is a cross-sectional view taken along line 2-2 of FIG. 1 showing a first embodiment in which opposed continuous front and rear layers hold conductors of both the membrane switch and touchscreen;

FIG. 3 is a figure similar to that of FIG. 2 showing a second embodiment employing a supplemental electrode support layer for the membrane switch; and

FIG. 4 is a figure similar to that of FIG. 2 showing an embodiment for producing a touchscreen with graphic margins using the techniques of the present invention.

### DETAILED DESCRIPTION OF THE PREFERRED EMBODIMENT

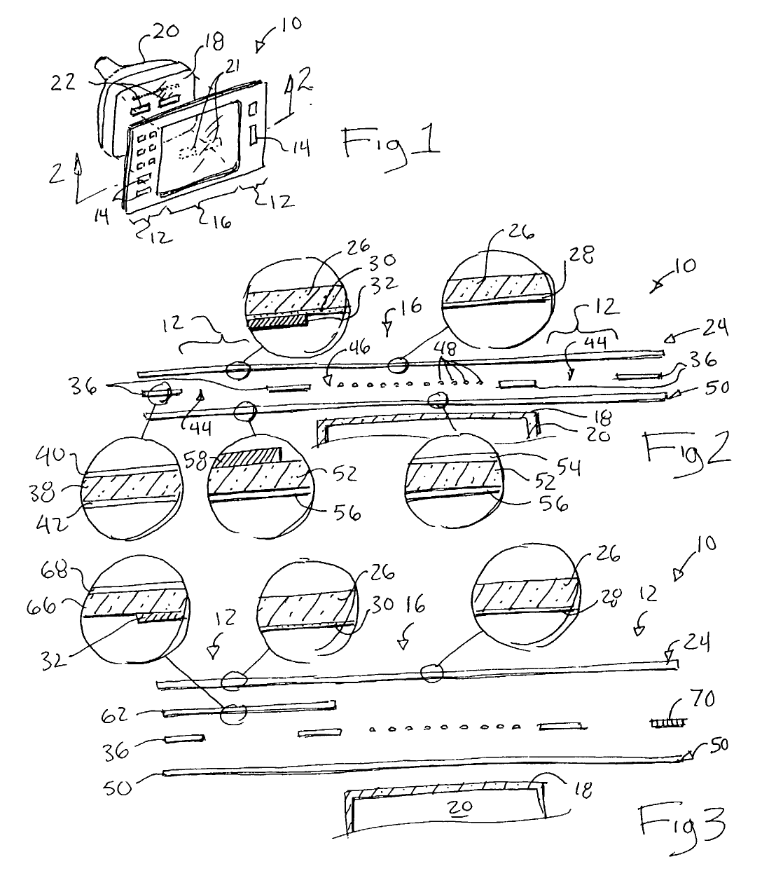

Referring now to FIG. 1, a combined touchscreen/membrane switch 10 provides graphic portions 12 having printed button symbols 14 and a transparent portion 16 through which the faceplate 18 of a graphic display 20 such as a cathode ray tube may be viewed.

In use, the touchscreen/membrane switch 10 allows a user to provide electrical inputs by pressing the button symbols 14 or by touching arbitrary areas 21 of the transparent portion 16 corresponding to images 22 on the faceplate 18 of the graphic display 20.

Referring now to FIG. 2, the combined touchscreen/membrane switch 10 provides a front layer 24 formed in part of a continuous, flexible and transparent sheet 26, for example, a heat stabilized polyester film. In the transparent portion 16, a rear surface of the transparent sheet 26 is coated with a transparent conductor 28 being, for example, indium tin oxide, or in the preferred embodiment, printed with a conductive polymer such as ORGACON, based on a polyethylene dioxithiophene and available from Agfa-Gevaert N. V. of Mortsel, Belgium. The transparent conductor 28 is generally evenly applied over the entire area of the transparent portion 16 commensurate with the area of the faceplate 18.

The conductive polymer is less costly than ITO thus allowing it to be applied to the entire surface of the front layer 24. Further, the conductive polymer may be printed to be applied to the transparent sheet 26 only where necessary. This is in contrast to the ITO which generally must be applied to the entire surface of the transparent sheet 26 and then etched away from regions where it is not desired.

Referring still to FIG. 2, the graphic portions 12 of front layer 24 has at its rear surface printed graphics 30 such as depict button symbols 14 or an opaque matrix surrounding them. The graphics 30 are printed on the rear surface of the transparent sheet 26 protecting them from abrasion. 100371 Also applied to the rear surface of transparent sheet 26 either behind the graphics 30 (as shown) or in portions where the graphics 30 are not placed, and thus directly attached to the transparent sheet 26, are low resistance conductors 32. Such conductors may, for example, be screen printed silver or carbon and are intended to present low resistance conductors in contrast to the higher more easily measured resistance of the material of the transparent conductor 28. The low resistance conductors 32 provide contact circuitry for the membrane switches as is understood in the art.

Positioned behind the front layer 24 is a spacer layer 36 comprised, for example, of an insulating plastic sheet 38 having a front and rear adhesive coating 40 and 42, respectively. The spacer layer 36 presents apertures 44 aligned with the button symbols 14 shown in FIG. 1 and contact pads of the low resistance conductors 32 of FIG. 2. The spacer layer 36 also presents an aperture 46 equal in area to the transparent portion 16 exposing the faceplate 18 of the graphic display 20. Optionally the spacer layer 36 also includes insulating dots 48 positioned in the transparent portion 16 as understood in the art and described above.

The spacer layer 36 separates the front layer 24 from a rear layer 50. Like front layer 24, rear layer 50 is formed in part of a continuous, flexible, and transparent sheet 52, for example, a heat stabilized polyester film. Alternatively, the rear layer may be a rigid transparent sheet such as plastic or glass or a rigid sheet in the transparent portion and a flexible sheet in the graphics portion 12.

In the transparent portion 16, the front surface of transparent sheet 52 is coated with the conductive polymer to provide a transparent conductor 54 opposing transparent conductor 28 of the front layer 24. A rear surface of the transparent sheet 52 supports an adhesive 56 allowing it to be adhered to the faceplate 18 of the graphic display 20.

At graphic portion 12, the transparent sheet 52 includes on its front surface, a low resistance conductor 58 being comparable to low resistance conductors 32 of the front layer 24 and printed, for example, of a silver or carbon ink. The low resistance conductor 32 provides contact circuitry working with contact circuitry formed by lower resistance conductors 32 on the front layer and also can provide interconnection circuitry for the membrane switches and the touch screen, connecting these elements to leads attached at the rear layer 50 of the touchscreen/membrane switch 10. The rear surface of the transparent sheet 52 of the graphic portion also provides adhesive 56 for attaching the graphics portion of the touchscreen/membrane switch 10 to a supporting substrate (not shown).

It will be understood that this embodiment provides an extremely simple construction. In alternative embodiments, the front layer 24 is continuous but the spacer layer 36 and the rear layer 50 need not be continuous but may be separate elements as desired. In addition, the rear layer 50 need not be a flexible material but may include, for example, printed circuit board material, glass, or the like.

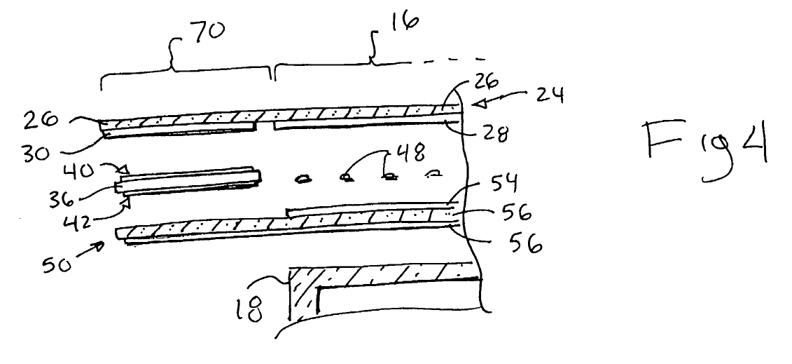

Referring now to FIG. 3, in a second embodiment, a supplemental electrode support layer 62 is added under the graphic portion 12 of the front layer 24 and in front of the spacer layer 36. The supplemental electrode support layer 62 is formed of a flexible material 66 having on its front surface an adhesive 68 to attach it to the rear surface of the front layer 24.

Generally, the supplemental electrode support layer 62 eliminates the need to place low resistance conductors 32 directly on graphics 30 as described above with respect to FIG. 2. The front layer 24 in the transparent portion 16, as before, is formed of transparent sheet 26 and transparent conductor 28. The front layer 24 in the graphic portion 12, however, supports only graphics 30 and does not support a low resistance conductor 32. Instead, the electrode support layer 62 supports low resistance conductors 32 on its rear surface standing in lieu of the front layer 24. Activation of the membrane switch must now deform both the front layer 24 and the supplemental electrode support layer 62; however, greater touch forces are more easily accommodated with the normal operation of a membrane switch.

The embodiment of FIG. 3 employs a rear layer 50 similar to that which has been described above.

In an alternative embodiment (not shown), the supplemental electrode support layer 62 may be replaced with a snap dome as is well known in the art.

Referring now to FIG. 3, the spacer layer 36 may incorporate one or more conductors 70 providing a path of conduction from the transparent conductor 28 on the front surface to electrical paths formed, for example, by low resistance conductor 58 on the rear layer 50 allowing external connections to the touchscreen/membrane switch 10 to be made exclusively at the rear layer 50 for manufacturing convenience. The conductor 70 may, for example, be a conductive epoxy, conductive tape or an anisotropically conductive paste for example 3M Z-Axis Adhesive paste commercially available from 3M Corporation of Minnesota such as allows for electrical conduction between front layer 24 and rear layer 50 with relatively little lateral or in-plane conduction.

Referring now to FIG. 4, the continuous front layer 24 provided by the present invention may also be used to produce a graphics margin 70 to the side of the transparent portion 16 in which the touchscreen is implemented. In this case, the transparent portion 16 is constructed as described above with respect to FIGS. 2 and 3. The graphic margin 70 uses the same transparent sheet 26 of the front layer 24 as is used in the transparent portion 16 but without the rear layer of transparent conductor 28. As was mentioned above, the use of a printable transparent conductor 28 makes this practical. The graphic margin 70 is not limited to regions around the edges of the transparent portion 16 but may also include small graphic regions positioned within the transparent portion 16 if so desired.

In place of the transparent conductor 29, in the graphics margin, the transparent sheet 26 has on its rear surface printed graphics 30 similar to those described above with respect to FIG. 2 but not of button symbols. In this embodiment, the graphics margin 70 does not include any membrane switch circuitry and is followed simply by a spacer layer 36 and a rear layer 50 having no switch conductors. The spacer layer 36 and the rear layer 50 may be otherwise constructed as described above. The graphic margin may be decorative or may provide instructions or the like to the user of the touchscreen. Again, the benefits of a continuous front layer 24 are obtained.

It is specifically intended that the present invention not be limited to the embodiments and illustrations contained herein, but include modified forms of those embodiments including portions of the embodiments and combinations of elements of different embodiments as come within the scope of the following claims.

I claim:

1. A combined touchscreen and membrane switch comprising:
a) a front layer formed of a continuous flexible sheet and having:
i) a transparent portion supporting a transparent conductor on a rear surface; and
ii) a graphic portion printed with button symbols;
b) a spacer layer positioned behind the front layer and having openings aligned with the transparent portion and at least one button symbol;
c) a transparent rear layer positioned behind the spacer layer supporting a transparent conductor on a front surface opposed to the transparent portion of the front layer; and
d) a membrane switch circuitry positioned behind the graphic portion and aligned with the button symbols to be activated upon pressing of the button symbols;
wherein a single surface is presented to the user having minimum resistance to touchscreen operation.

2. The combined touchscreen and membrane switch recited in claim 1 wherein the rear layer is rigid transparent sheet selected from the group consisting of glass and transparent plastic.

3. The combined touchscreen and membrane switch recited in claim 1 wherein the rear layer is flexible sheet facing graphic portion and rigid sheet facing transparent opening for touchscreen

4. The combined touchscreen and membrane switch recited in claim 1 wherein the graphic portion of the front layer also supports a conductor on a rear surface.

5. The combined touchscreen and membrane switch recited in claim 4 wherein the conductor on the rear surface of the graphics portion is of a material different from the conductor on the rear surface of the transparent portion of the front layer.

6. The combined touchscreen and membrane switch recited in claim 4 wherein the conductor on the rear surface of the graphic portion of the front layer is silver ink.

7. The combined touchscreen and membrane switch recited in claim 4 wherein the conductor on the rear surface of the transparent portion of the front layer is a conductive polymer.

8. The combined touchscreen and membrane switch recited in claim 4 wherein the conductor on the rear surface of the transparent portion of the front layer is an indium tin oxide.

9. The combined touchscreen and membrane switch recited in claim 1 including further a supplemental electrode support layer positioned between the graphics portion of the front layer and the spacer layer, wherein the supplemental electrode support layer supports a conductor on a rear surface.

10. The combined touchscreen and membrane switch recited in claim 8 wherein the conductor on the rear surface of the supplemental electrode support layer is silver ink.

11. The combined touchscreen and membrane switch recited in claim 1 wherein the transparent rear layer extends behind both the transparent portion and the graphics portion of the front layer and wherein the membrane switch circuitry includes a conductor supported on the front surface of the rear layer behind the graphics portion of the front layer.

12. The combined touchscreen and membrane switch recited in claim 11 wherein the conductor supported on the front surface of the rear layer behind the graphics portion are of a material different from the transparent conductor on the front surface of the rear layer behind the transparent portion of the front layer.

13. The combined touchscreen and membrane switch recited in claim 12 wherein the conductor on the front surface of the rear layer behind the graphics portion is silver ink.

14. The combined touchscreen and membrane switch recited in claim 13 wherein the conductor on the front surface of the rear layer behind the transparent portion of the front layer is a conductive polymer.

16. The combined touchscreen and membrane switch recited in claim 13 wherein the conductor on the rear surface of the transparent portion of the front layer is an indium tin oxide.

17. The combined touchscreen and membrane switch recited in claim 11 including further a supplemental electrode support layer positioned between the graphics portion of the front layer and the spacer layer, wherein the supplemental electrode support layer supports a conductor on a rear surface.

18. The combined touchscreen and membrane switch recited in claim 17 wherein the conductor on the rear surface of the supplemental electrode support layer is silver ink.

19. The combined touchscreen and membrane switch recited in claim 1 wherein the spacer layer provides a conductive path between the front layer and the rear layer allowing eternal electrical connections to be made solely at the rear layer.

20. A touchscreen with graphic margin comprising:
a) a front layer formed of a continuous flexible sheet and having:
i) a transparent portion supporting a transparent conductor on a rear surface; and
ii) a graphic portion proximate to the transparent portion printed with graphics;
b) a spacer layer positioned behind the front layer and having at least one opening aligned with the transparent portion;
c) a transparent rear layer positioned behind the spacer layer supporting a transparent conductor on a front surface opposed to the transparent portion of the front layer; and
wherein a single surface is presented to the user having minimum resistance to touchscreen operation.
